(19) United States
(12) Patent Application Publication
(10) Pub. No.: US 2012/0141218 A1
(43) Pub. Date: Jun. 7, 2012

(54) HAND DRILL

(75) Inventors: Manabu SAITO, Tokyo (JP); Tatsuo NAKAHATA, Tokyo (JP); Hideharu TAKAHASHI, Tokyo (JP)

(73) Assignee: FUJI JUKOGYO KABUSHIKI KAISHA, Tokyo (JP)

(21) Appl. No.: 13/312,474

(22) Filed: Dec. 6, 2011

(30) Foreign Application Priority Data
Dec. 7, 2010 (JP) 2010-272829

(51) Int. Cl. B23B 45/14

(52) U.S. Cl. 408/110

(57) ABSTRACT

The object of the invention is to provide a hand drill that capable of suppressing delamination that occurs when drilling holes in an object, as well as being more compact. The hand drill has a base member, a damper, a drill and drill blade. The base member has a contact surface that comes in contact with an object being drilled, and a drill bushing. The damper comprises a piston rod and a cylinder, and extends or contracts in its own axial direction. The tip end section of the piston rod is fastened to the base member. The drill is fastened to the cylinder and displaces together with the cylinder. The drill blade is installed in the drill so that it is parallel to the axial direction of the damper. When the damper is in the extended state, the tip end of the drill blade is located at the tip end of the drill bushing.

### CROSS REFERENCE TO RELATED APPLICATIONS

This application claims priority under 35 U.S.C. 119 based upon Japanese Patent Application Serial No. 2010-272829, filed on Dec. 7, 2010. The entire disclosures of the aforesaid applications are incorporated herein by reference.

### FIELD OF THE INVENTION

The present invention relates to a hand drill, and more particularly to a hand drill having a damper for controlling the feeding speed of the drill blade.

### BACKGROUND OF THE INVENTION

Japanese Laid-open Patent Publication No. 2008-149432 discloses a method of suppressing delamination, which occurs when drilling holes in an object, by providing a damper in each of two guide rods that are fixed to a hand drill in order to control the feeding speed of a drill blade. More specifically, the guide rods are formed such that they extend and contract along the feed direction of the drill blade, with the speed of expansion and contraction being controlled by the dampers. The tip of each guide rod is fixed to one contact plate. A through hole through which the drill passes is formed in the contact plate. When drilling holes in an object, the contact plate is brought in contact with the object in which a hole is to be drilled, and the hand drill is pressed toward the contact plate. As a result, the drill blade protrudes through the through hole, and drills a hole into the object. When this happens, the hand drill is fastened to the guide rods, so the hand drill displaces with the guide rods. Therefore, the feeding speed of the drill blade is controlled by the dampers provided to the guide rods.

However, because there are two guide rods attached to the hand drill, there is a problem that the entire device becomes large. On the other hand, by using only one guide rod, it may be possible to make the overall device smaller, however, the contact plate and guide rod must be fastened at one point, so there is a problem that positioning the drill blade with respect to the through hole of the contact plate becomes difficult. Moreover, depending on the method of fastening the contact plate and the guide rod, there is a problem of the contact plate turning around the axis of the guide rod.

The object of the present invention is to provide a hand drill that is capable of suppressing delamination that occurs when drilling holes in an object, and that can be made more compact.

### SUMMARY OF THE INVENTION

According to a first embodiment of the present invention for achieving the purpose described above, there is provided
a hand drill comprising:
a drill main body for holding a drill blade and for rotating the drill blade around the center axis thereof;
a damper having a cylinder fastened to the drill main body and a piston rod supported by the cylinder; the piston rod being arranged parallel to the drill blade and having a tip end portion and a base end portion that is located inside the cylinder, and the cylinder supporting the piston rod so that the piston rod is movable in a forward or backward direction parallel to the center axis of the drill blade; and
a base member fixed to the tip end portion of the piston rod, wherein the base member has a contact surface that comes in contact with an object to be drilled by the drill blade, and has a penetration portion in which the drill blade is inserted;
wherein
the drill blade is located inside the penetration portion in a state that the piston rod is moved forward all the way toward the object, and
the hand drill is constructed so that when the contact surface contacts with the object and the drill main body is pressed toward the object, the piston rod is moved backward toward the cylinder, and the drill blade advances in the penetration portion toward the object.

According to a second embodiment of the present invention for achieving the purpose above, it is preferable that in the hand drill, the penetration portion has sliding contact with an outer circumferential surface of the drill blade.

According to a third embodiment of the present invention for achieving the purpose above, it is preferable that in the hand drill, a drill bush having a through hole at the center of the drill bush is fixed to the base member, and the penetration portion is formed by the through hole of the drill bush, and one end of the drill bush protrudes toward the object relative to the contact surface.

According to a fourth embodiment of the present invention for achieving the purpose above, it is preferable that in the hand drill, when the piston rod is moved forward all the way toward the object, a position of the tip end of the drill blade coincides with a position of an opening end of the penetration portion facing the object.

With the present invention, the drill main body is fixed to the cylinder, so the drill main body displaces with the cylinder. The tip end portion of the piston rod is fixed to the base member, so when the contact surface of the base member is in contact with an object to be drilled, by pressing the drill toward the base member, the feeding speed of the drill blade can be controlled. Therefore, it is possible to suppress delamination that occurs when drilling holes in an object. When the damper is in the extended state, the drill blade is inserted into the penetrating portion of the base member, so it is not necessary to adjust the position the drill blade. Furthermore, although there is only one damper, it is possible for the drill blade to restrict the rotation of the base member around the center axis of the damper, so when compared with the invention disclosed in Japanese Laid-open Patent Publication No. 2008-149432 that requires two guide rods, it is possible to make the hand drill more compact.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a schematic exterior view of a hand drill of an embodiment of the present invention.

FIG. 2 is an exterior view of the plate as see from the drill side.

FIG. 3 is an exterior view of the state of the drill bushing fastened to the plate as seen from the drill side.

FIG. 4 is an exterior view of the base member as seen from the contact surface side.

FIG. 5 is an exterior view of the connector as seen from the drill side.

FIG. 6 is an explanative drawing illustrating the drilling of a hole using the hand drill.

### DETAILED DESCRIPTION OF THE INVENTION

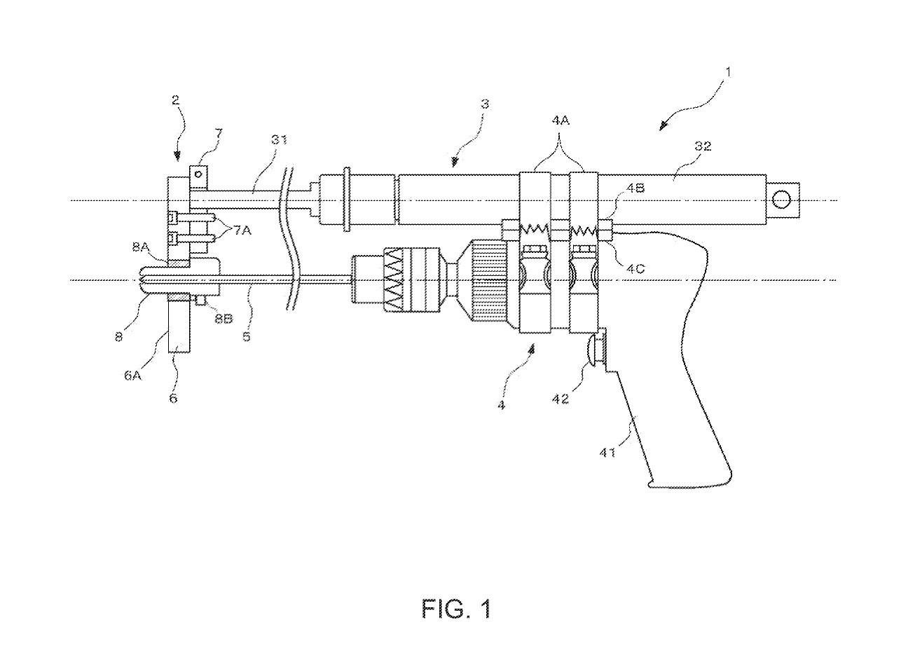

FIG. 1 is a schematic exterior view of a hand drill of an embodiment of the present invention. The hand drill 1 has a base member 2, a damper 3, a drill 4, and drill blade 5. In FIG. 1, the area around the base 2 (explained later) is illustrated as a cross section, and other parts are illustrated as an exterior view. The damper 3 comprises a piston rod 31 and a cylinder 32. The tip end of the piston rod 31 is fastened to the base member 2. The cylinder 32 houses the piston rod 31 inside and supports the piston rod 31 such that the piston rod can freely move in and out in the axial direction of the damper 3. In other words, the damper 3extends or contracts in its own axial direction, and functions as resistance to external force acting in the direction of extension or contraction. FIG. 1 is a drawing that illustrates the extended state of the damper 3. The same state is illustrated in the other drawings as well.

The drill 4 has a grip section 41 that is gripped in the hand of the operator, and by the operator pressing the button 42 that is provided on this grip section 41, the electric hand drill causes the drill blade 5 to rotate around its axis. Two bands 4A fasten this drill 4 to the cylinder 32 by way of two rectangular plate shaped spacers 4B, 4C. The spacer 4B has a concave section on the surface that comes in contact with the damper 3 that corresponds to the outer circumferential surface of the damper 3. The spacer 4C has a concave section on the surface that comes in contact with the drill 4 that corresponds to the outer circumferential surface of the drill 4. By adjusting the thickness of the spacers 4B, 4C, it is possible to adjust the spacing between the damper 3 and the drill 4. The drill blade 5 is attached to the drill 4 such that it is parallel with the axial direction of the damper 3.

The base member 2 comprises a plate 6, a connector 7 and a drill bushing 8. The plate 6 has a contact surface 6A that comes in contract with the object being drilled (not illustrated in the figure). The connector 7 is fastened to the plate 6 by two screws 7A, and connects to the tip end section of the piston rod 31. The drill bushing 8 is fastened to the plate 6 by way of a cylindrical shaped liner bushing 8A.

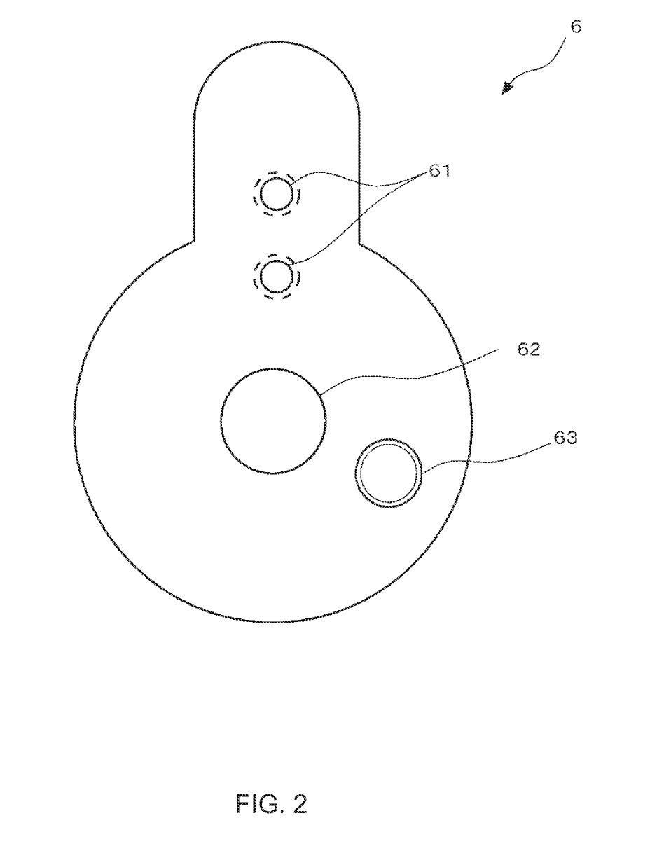

FIG. 2 is an exterior view of the plate 6 as seen from the drill 4 side. The plate 6 is formed in a disk shape having a protruding section that protrudes toward the outside in the radial direction. Two screw holes 61 are formed in this protruding section. The screws 7A for fastening to the connector 7 are inserted in the screw holes 61 (FIG. 1). A through hole 62 in which the liner bushing 8A is pressure fitted, is formed in the center of the plate 6. A screw hole 63 is formed near this through hole 62.

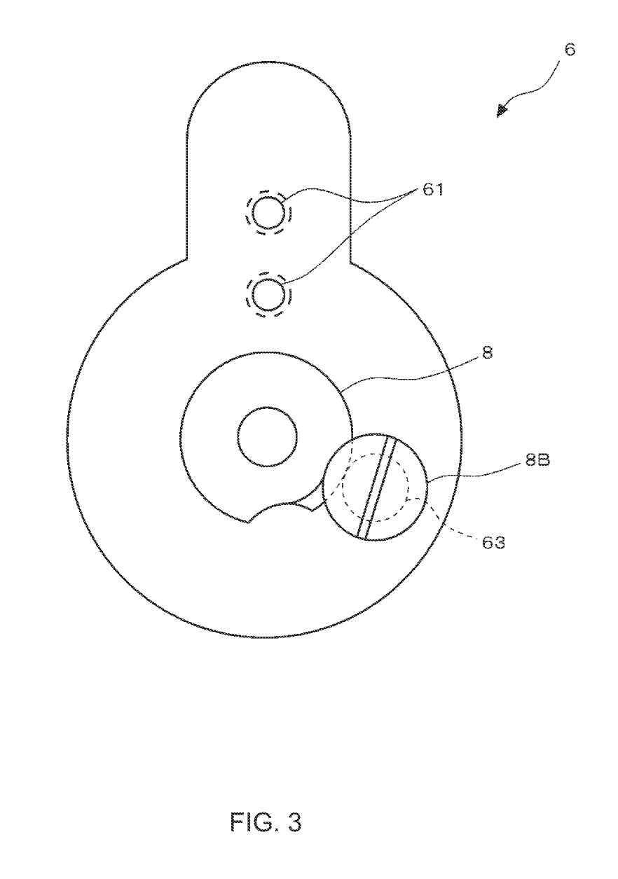

FIG. 3 is an exterior view of the state in which the drill bushing 8 is fastened in the plate 6 as seen from the drill 4 side. The drill bushing 8 that functions as a through hole section is formed in a cylindrical shape, and the tip end section thereof is inserted inside the liner bushing 8A and fastened (FIG. 1). The base end section of the drill bushing 8 has an outer diameter that is larger than that of the tip end section. A notch is formed around the outer circumferential surface of the base end section. When this notch comes in contact with the set screw 8B that is screwed into the screw hole 63, the rotation of the drill bushing 8 (rotation in the clockwise direction in FIG. 3), and lifting toward the drill 4 side is controlled.

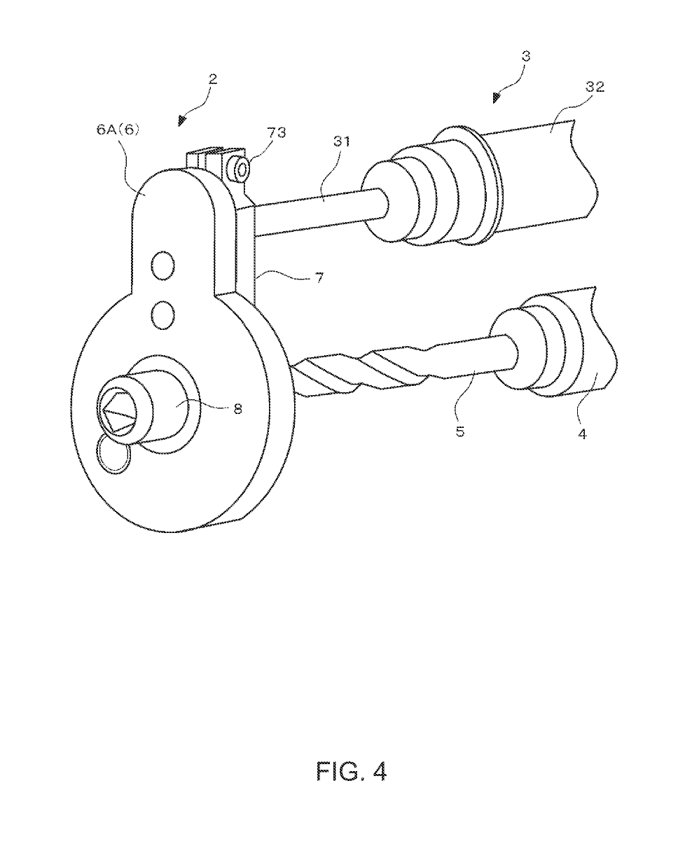

FIG. 4 is an exterior view of the base member 2 as seen from the contact surface 6A side. The drill bushing 8 has an inner diameter that has a sliding fit with the drill blade 5, and guides the drill blade 5. The sliding fit referred to here is sliding between two members. More specifically, the inner diameter of the drill bushing 8 is designed to be a little larger than the outer diameter of the drill blade 5. The tip end section of the drill bushing 8 protrudes from the contact surface 6A. When the damper 3 is extended, the tip end of the drill blade 5 is located at the tip end (opening end) of the drill bushing 8.

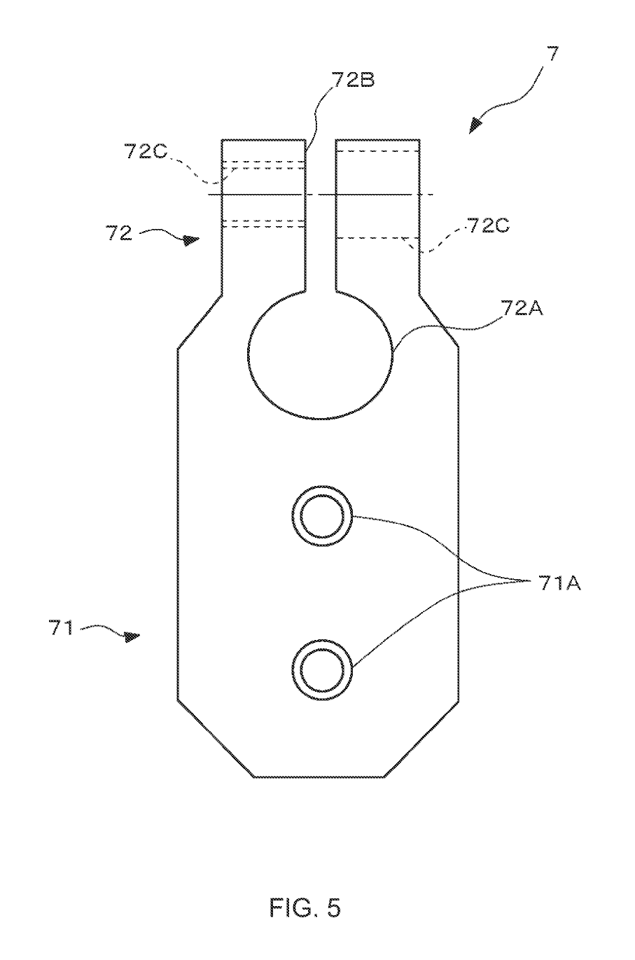

FIG. 5 is an exterior view of the connector 7 as seen from the drill 4 side. The connector 7 is rectangular shaped and comprises a fastening section 71 for fastening to the plate 6, and a connecting section 72 for connecting to the tip end section of the piston rod 31. Two screw holes 71A are formed in the fastening section 71. Screws 7A are screwed into the screw holes 71A by way of the screw holes 61 in the plate 6. The connecting section 72 has a through hole 72A that passes through from the front surface to the rear surface, a cutout section 72B that is cut out in a linear shape in a lengthwise direction from the side surface of the top side in FIG. 3 to the through hole 72A, and screw holes 72C that are formed on both sides of the cutout section 72B in the traverse direction. By screwing a screw 73 (FIG. 4) into the screw hole 72C of this connecting section 72, the width of the cutout section 72B can be adjusted, and the inner diameter of the through hole 72A can be made larger or smaller. The tip end section of the piston rod 31 inserted into the through hole 72A and with that tip end section in contact with the plate 6, the piston rod 31 is fastened to the base member 2 by tightening the screw 73.

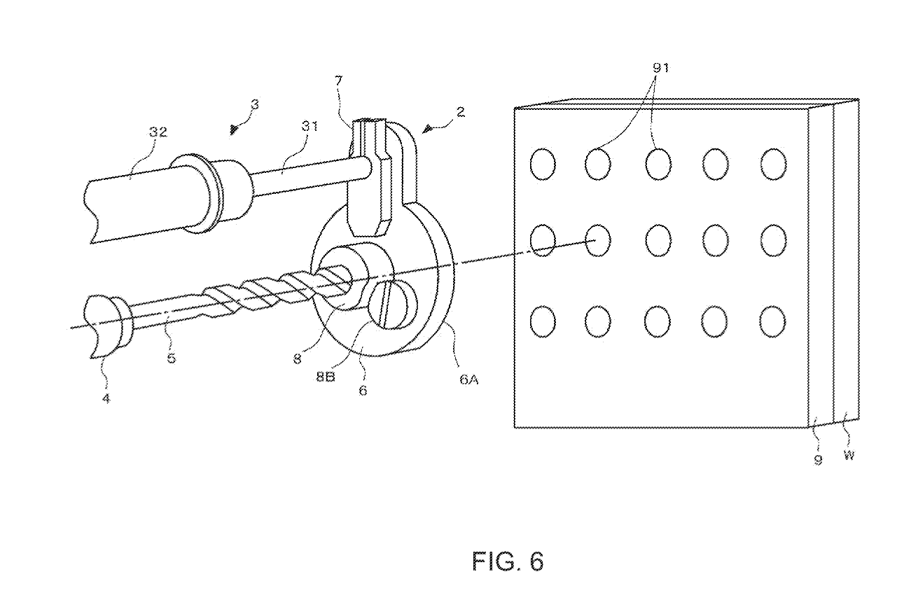

FIG. 6 is an explanative drawing that illustrates the drilling of holes in an object using the hand drill 1. A template 9 has a plurality of through holes 91 that are formed such that the drill bushing 8 fits inside inner diameter side. Each of the through holes 91 is formed in a location that corresponds to the hole to be drilled in the drilled object W. When drilling holes in the drilled object W using the hand drill 1, the holes are drilled with this template 9 combined with the drilled object W. First, the tip end section of the drill bushing 8 is fitted inside a through hole 91, and the contact surface 6A of the base member 2 is brought into contact with the template 9. Next, by pressing the button 42, the drill blade 5 is rotated and the drill 4 is then pressed into the base member 2. As a result, the drill blade 5 protrudes from the drill bushing 8 and drills a hole into the object W. When doing this, the drill 4 is fastened to the cylinder 32, so the drill 4 displaces together with the cylinder 32. Therefore, the damper 3 controls the feeding speed of the drill blade 5.

Here, when the damper 3 is in the extended state, the tip end of the drill blade 5 is located at the tip end of the drill bushing 8, so when compared with the state in which the tip end of the drill blade 5 is located inside the drill bushing 8, the amount that the drill is pressed when drilling a hole in the drilled object W can be reduced.

In this way, with this embodiment, when the contact surface 6A of the base member 2 is in contact with the drilled object W, it is possible to control the feeding speed of the drill blade 5 by pressing the drill 4 toward the base member 2. Therefore, it is possible to suppress delamination that occurs when drilling holes in an object W. Moreover, when the damper 3 is extended, the drill blade 5 is inserted into the drill bushing 8 of the base member 2, so it is not necessary to position the drill blade 5. Furthermore, it is possible to control the rotation of the base member 2 around the axis of the damper 3, so when compared with invention in Japanese Patent Application No. 2008-149432 in which two guide rods are necessary, it is possible to make the hand drill 1 more compact.

Generally, when using a hand drill to drill a hole in an object, the drill bushing is fitted in a through hole of a template beforehand, and the hole is drilled by inserting the drill blade into the drill bushing. Therefore, there is a problem in that the drill blade may come in contact with the drill bushing and become chipped. However, in this embodiment, the drill blade 5 is inserted into the drill bushing 8 beforehand, so such a problem does not occur.

In the embodiment described above, the drill bushing 8 has an inner diameter that forms a sliding fit with the drill blade 5, however, the drill bushing does not have to have an inner diameter that forms a sliding fit with the drill blade. The drill bushing could have a diameter that is larger than the outer diameter of drill blade. Moreover, the tip end section of the drill bushing 8 protrudes from the contact surface 6A, however, does not have to protrude from the contact surface.

In the embodiment described above, a through hole section is formed by fastening the drill bushing 8 to the plate 6, however, for example, a through hole section could be formed in the base member. The through hole section can be formed in the base member such that it is open through to the contact surface.

Furthermore, in the embodiment described above, the tip end of the drill blade 5 is located at the tip end of the drill bushing 8 when the damper 3 is in the extended state, however, does not need to be located inside the drill bushing 8. The drill blade can be inserted into the through hole section when the damper is in the extended state.

In the embodiment described above, the base member, damper, drill and drill blade are all separate members, however they can also be integrated as one member. Furthermore, an example of an electric hand drill was given as the drill 4, however, a manual hand drill can also be used as the drill.

### INDUSTRIAL APPLICABILITY

As described above, the present invention can be widely applied to hand drills having a damper for controlling the feeding speed of the drill blade.

It is to be understood that the above-described embodiments are illustrative of only a few of the many possible specific embodiments which can represent applications of the principles of the invention. Numerous and varied other arrangements can be readily devised by those skilled in the art without departing from the spirit and scope of the invention.

What is claimed is:

1. A hand drill comprising:
a drill main body for holding a drill blade and for rotating the drill blade around the center axis thereof;
a damper having a cylinder fastened to the drill main body and a piston rod supported by the cylinder; the piston rod being arranged parallel to the drill blade and having a tip end portion and a base end portion that is located inside the cylinder, and the cylinder supporting the piston rod so that the piston rod is movable in a forward or backward direction parallel to the center axis of the drill blade; and
a base member fixed to the tip end portion of the piston rod, wherein the base member has a contact surface that comes in contact with an object to be drilled by the drill blade, and has a penetration portion in which the drill blade is inserted;
wherein
the drill blade is located inside the penetration portion in a state that the piston rod is moved forward all the way toward the object, and
the hand drill is constructed so that when the contact surface contacts with the object and the drill main body is pressed toward the object, the piston rod is moved backward toward the cylinder, and the drill blade advances in the penetration portion toward the object.

2. The hand drill according to claim 1, wherein
the penetration portion has sliding contact with an outer circumferential surface of the drill blade.

3. The hand drill according to claim 1, wherein
a drill bush having a through hole at the center of the drill bush is fixed to the base member, and the penetration portion is formed by the through hole of the drill bush, and
one end of the drill bush protrudes toward the object relative to the contact surface.

4. The hand drill according to claim 1, wherein
when the piston rod is moved forward all the way toward the object, a position of the tip end of the drill blade coincides with a position of an opening end of the penetration portion facing the object.
